(19) United States
(12) Patent Application Publication
(10) Pub. No.: US 2004/0186819 A1
(43) Pub. Date: Sep. 23, 2004

(54) Telephone directory information retrieval system and method

(75) Inventor: James K. Baker, Maitland, FL (US)

Correspondence Address: FOLEY AND LARDNER, SUITE 500, 3000 K STREET NW, WASHINGTON, DC, 20007, US

(73) Assignee: Aurilab, LLC

(21) Appl. No.: 10/389,750

(22) Filed: Mar. 18, 2003

(51) Int. Cl. G06F 7/00

(52) U.S. Cl. 707/1

(57) ABSTRACT

A database retrieval system obtains telephone directory information, and includes a speech receiving unit that outputs an acoustic observation sequence corresponding to a speaker's utterance of a first name and last name of someone for whom a telephone number is desired. The system also includes a speech recognition processing unit that performs speech recognition processing on acoustic observations, to obtain a list of candidate hypotheses, and to obtain a match score for each candidate hypothesis. The system further includes a hypothesis evaluating unit that determines whether any candidate hypothesis has an initial for a first name part of the corresponding database entry, to generate all consistent first names, and to obtain a plurality of generated hypotheses corresponding to each of the generated first names. The speech recognition processing unit performs another speech recognition processing on the acoustic observation sequence, to obtain a match score for each generated hypothesis. The hypothesis evaluation unit updates a match score for each candidate hypothesis to a highest match score of the corresponding ones of the generated hypotheses, and a best scoring candidate hypothesis is used to obtain information from a database.

### DESCRIPTION OF THE RELATED ART

For conventional telephone directory systems and methods, a customer calls a particular telephone number (e.g., “411”) in order to obtain a desired phone number for someone that the customer wishes to call. Typically, as soon as the customer is connected to the particular telephone number, the customer is prompted by an automatic voice prompt to speak a “City and State” of the person for whom the customer seeks the phone number. The customer is then prompted by the automatic voice prompt to speak a “First Name and Last Name” of the person for whom the customer seeks the phone number. This information is utilized in order to retrieve the proper phone number from a telephone directory database.

However, when the first name and last name do not exactly match the person's name as it appears in the telephone directory database, there is a problem in that the customer will not be provided with the information desired, since the non-exact match will be considered by the telephone operator as corresponding to a different person, when in fact it is the person for whom the customer wants the phone number.

This is especially the case when the customer utters a full first name of a person, and where the database only stores that person's name with a first initial. This is a frequent occurrence, especially for a person who desires that their first name be stored in a telephone directory as a first initial for security reasons (e.g., a female who does not want strangers to know that an adult male does not reside at her address).

Furthermore, many conventional telephone directory assistance systems and methods do not utilize speech recognition in trying to obtain the desired phone number for a caller. Even in the non-automated systems, the caller is first prompted to speak the city and state. For example, when a caller is prompted to speak a “name” of a person to be called and then prompted to speak a “city and state” of the person to be called, the caller's utterances are recorded, and those recorded utterances are played back to a telephone directory assistant. The telephone directory assistant must then quickly decipher the caller's utterances, which may be a difficult task if the name spoken by the caller is a strange-sounding name (e.g., foreign-sounding name or unusual name). In that case, it is likely that the telephone directory assistant will not be able to determine the correct name (and thus the correct phone number) from a telephone directory database based on the caller's utterance, and time will be wasted by the telephone directory assistant having to request the caller to re-speak the name and/or city and state of the person-to-be-called, or by requesting additional information of the person-to-be-called from the caller (which of course makes the caller not want to utilize such a service in the future, given the time delay in obtaining the desired information). Accordingly, speech recognition can be a useful feature for telephone directory assistance.

However, when speech recognition is utilized in telephone directory assistance methods and systems, other problems may occur when information is attempted to be retrieved from a telephone directory database, whereby the present invention has been developed to deal with some of those problems. For example, when a speaker speaks a nickname or some other partial name for a first name of a person-to-be-called that is not the way that person's first name is stored in the telephone directory database, or if the speaker speaks a full first name of a person-to-be-called whereby that person's first name is stored in the database as an initial, the use of speech recognition software in a telephone directory assistance system or method may actually perform worse than in a case in which speech recognition software is not used.

The present invention is directed to overcoming or at least reducing the effects of one or more of the problems set forth above.

### SUMMARY OF THE INVENTION

According to one embodiment of the invention, there is provided a method for obtaining telephone directory information from a database. The method includes determining a sequence of acoustic observations corresponding to a speaker's utterance, the speaker's utterance including at least a first name and last name of a person for whom the speaker desires to be provided with a telephone number. The method also includes performing a first speech recognition processing on the sequence of acoustic observations, in order to obtain a list of candidate hypotheses that have corresponding database entries in the database. The method further includes obtaining a match score for each of the list of candidate hypotheses with respect to the sequence of acoustic observations. The method still further includes determining whether or not any of the list of candidate hypotheses has an initial, abbreviation or nickname for a first name part of the corresponding database entry. The method also includes, if the determination is that none of the list of candidate hypotheses has an initial, abbreviation or nickname for the first name part, then determining one of the list of candidate hypotheses having a highest matching score as a recognized answer to be utilized to retrieve the telephone directory information from the database. The method still further includes, if the determination made in a previous step is that at least one of the list of candidate hypotheses has an initial, abbreviation or nickname for the first name part, then performing the following steps for each one of the list of candidate hypotheses having an initial, abbreviation or nickname, a) generating all first names consistent with the initial, abbreviation or nickname, and obtaining a plurality of generated hypotheses corresponding to each of the generated first names; b) performing a second speech recognition processing for the sequence of acoustic observations with respect to the plurality of generated hypotheses; c) obtaining a match score for each of the plurality of generated hypotheses with respect to the sequence of acoustic observations; d) updating a match score for each of corresponding ones of the list of candidate hypotheses having an initial, abbreviation, or nickname, to be updated to a highest match score of the corresponding ones of the plurality of generated hypotheses. The method also includes determining a best scoring one of the list of candidate hypotheses as a recognized answer to be utilized to retrieve the telephone directory information from the database.

According to another embodiment of the invention, there is provided a database retrieval system for obtaining telephone directory information. The system includes a speech receiving unit configured to output a sequence of acoustic observations corresponding to a speaker's utterance, the speaker's utterance including at least a first name and last name of a person for whom the speaker desires to be provided with a telephone number of. The system also includes a speech recognition processing unit configured to perform a first speech recognition processing on the sequence of acoustic observations, to obtain a list of candidate hypotheses that have corresponding database entries in the database, and to obtain a match score for each of the list of candidate hypotheses with respect to the sequence of acoustic observations. The system further includes a hypothesis evaluating unit configured to determine whether or not any of the list of candidate hypotheses has an initial, abbreviation or nickname for a first name part of the corresponding database entry, to generate all first names consistent with the initial, abbreviation or nickname, and to obtain a plurality of generated hypotheses corresponding to each of the generated first names. The speech recognition processing unit performs a second speech recognition processing on the sequence of acoustic observations with respect to the plurality of generated hypotheses, to obtain a match score for each of the plurality of generated hypotheses with respect to the sequence of acoustic observations. The hypothesis evaluation unit is configured to update a match score for each of corresponding ones of the list of candidate hypotheses having an initial, abbreviation, or nickname, to be updated to a highest match score of the corresponding ones of the plurality of generated hypotheses. The hypothesis evaluation unit is configured to determine a best scoring one of the list of candidate hypotheses as a recognized answer that is utilized to retrieve the telephone directory information from a corresponding entry in the database.

According to yet another embodiment of the invention, there is provided a program product having machine-readable program code for obtaining telephone directory information from a database, in which the program code, when executed, causes a machine to determine a sequence of acoustic observations corresponding to a speaker's utterance, the speaker's utterance including at least a first name and last name of a person for whom the speaker desires to be provided with a telephone number of. The program code also causes the machine to perform a first speech recognition processing on the sequence of acoustic observations, in order to obtain a list of candidate hypotheses that have corresponding database entries in the database. The program code also causes the machine to obtain a match score for each of the list of candidate hypotheses with respect to the sequence of acoustic observations. The program code also causes the machine to determine whether or not any of the list of candidate hypotheses has an initial, abbreviation or nickname for a first name part of the corresponding database entry. The program code also causes the machine to, if the determination is that none of the list of candidate hypotheses has an initial, abbreviation or nickname for the first name part, then determine one of the list of candidate hypotheses having a highest matching score as a recognized answer to be utilized to retrieve the telephone directory information from the database. The program code also causes the machine to, if the determination made in a previous step is that at least one of the list of candidate hypotheses has an initial, abbreviation or nickname for the first name part, then perform the following steps for each one of the list of candidate hypotheses having an initial, abbreviation or nickname, a) generating all first names consistent with the initial, abbreviation or nickname, and obtaining a plurality of generated hypotheses corresponding to each of the generated first names; b) performing a second speech recognition processing for the sequence of acoustic observations with respect to the plurality of generated hypotheses; c) obtaining a match score for each of the plurality of generated hypotheses with respect to the sequence of acoustic observations; d) updating a match score for each of corresponding ones of the list of candidate hypotheses having an initial, abbreviation, or nickname, to be updated to a highest match score of the corresponding ones of the plurality of generated hypotheses. The program code also causes the machine to determine a best scoring one of the list of candidate hypotheses as a recognized answer to be utilized to retrieve the telephone directory information from the database.

### BRIEF DESCRIPTION OF THE DRAWINGS

The foregoing advantages and features of the invention will become apparent upon reference to the following detailed description and the accompanying drawings, of which:

FIG. 1 is a flow chart of a telephone directory information retrieval system according to a first embodiment of the invention;

FIG. 2 is a block diagram of a telephone directory information retrieval system according to the first embodiment of the invention;

FIG. 3 is a flow chart of a telephone directory information retrieval system according to a second embodiment of the invention;

FIG. 4 is a flow chart of a telephone directory information retrieval system according to a third embodiment of the invention;

FIG. 5 is a block diagram of a priority queue with entries shown, in order to explain aspects of various embodiments of the invention; and

FIG. 6 provides an example of a grammar expansion based on address information in candidate hypotheses, according to at least one embodiment of the invention.

### DETAILED DESCRIPTION OF SPECIFIC EMBODIMENTS

The invention is described below with reference to drawings. These drawings illustrate certain details of specific embodiments that implement the systems and methods and programs of the present invention. However, describing the invention with drawings should not be construed as imposing, on the invention, any limitations that may be present in the drawings. The present invention contemplates methods, systems and program products on any computer readable media for accomplishing its operations. The embodiments of the present invention may be implemented using an existing computer processor, or by a special purpose computer processor incorporated for this or another purpose or by a hardwired system.

As noted above, embodiments within the scope of the present invention include program products comprising computer-readable media for carrying or having computer-executable instructions or data structures stored thereon. Such computer-readable media can be any available media which can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above are also be included within the scope of computer-readable media. Computer-executable instructions comprise, for example, instructions and data which cause a general purpose computer, special purpose computer, or special purpose processing device to perform a certain function or group of functions.

The invention will be described in the general context of method steps which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

The present invention in some embodiments, may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a conventional computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated computer-readable media provide nonvolatile storage of computer-executable instructions, data structures, program modules and other data for the computer.

The following terms may be used in the description of the invention and include new terms and terms that are given special meanings.

“Linguistic element” is a unit of written or spoken language.

“Speech element” is an interval of speech with an associated name. The name may be the word, syllable or phoneme being spoken during the interval of speech, or may be an abstract symbol such as an automatically generated phonetic symbol that represents the system's labeling of the sound that is heard during the speech interval.

“Priority queue” in a search system is a list (the queue) of hypotheses rank ordered by some criterion (the priority). In a speech recognition search, each hypothesis is a sequence of speech elements or a combination of such sequences for different portions of the total interval of speech being analyzed. The priority criterion may be a score which estimates how well the hypothesis matches a set of observations, or it may be an estimate of the time at which the sequence of speech elements begins or ends, or any other measurable property of each hypothesis that is useful in guiding the search through the space of possible hypotheses. A priority queue may be used by a stack decoder or by a branch-and-bound type search system. A search based on a priority queue typically will choose one or more hypotheses, from among those on the queue, to be extended. Typically each chosen hypothesis will be extended by one speech element. Depending on the priority criterion, a priority queue can implement either a best-first search or a breadth-first search or an intermediate search strategy.

“Frame” for purposes of this invention is a fixed or variable unit of time which is the shortest time unit analyzed by a given system or subsystem. A frame may be a fixed unit, such as 10 milliseconds in a system which performs spectral signal processing once every 10 milliseconds, or it may be a data dependent variable unit such as an estimated pitch period or the interval that a phoneme recognizer has associated with a particular recognized phoneme or phonetic segment. Note that, contrary to prior art systems, the use of the word “frame” does not imply that the time unit is a fixed interval or that the same frames are used in all subsystems of a given system.

“Stack decoder” is a search system that uses a priority queue. A stack decoder may be used to implement a best first search. The term stack decoder also refers to a system implemented with multiple priority queues, such as a multi-stack decoder with a separate priority queue for each frame, based on the estimated ending frame of each hypothesis. Such a multi-stack decoder is equivalent to a stack decoder with a single priority queue in which the priority queue is sorted first by ending time of each hypothesis and then sorted by score only as a tie-breaker for hypotheses that end at the same time. Thus a stack decoder may implement either a best first search or a search that is more nearly breadth first and that is similar to the frame synchronous beam search.

“Score” is a numerical evaluation of how well a given hypothesis matches some set of observations. Depending on the conventions in a particular implementation, better matches might be represented by higher scores (such as with probabilities or logarithms of probabilities) or by lower scores (such as with negative log probabilities or spectral distances). Scores may be either positive or negative. The score may also include a measure of the relative likelihood of the sequence of linguistic elements associated with the given hypothesis, such as the a priori probability of the word sequence in a sentence.

“Dynamic programming match scoring” is a process of computing the degree of match between a network or a sequence of models and a sequence of acoustic observations by using dynamic programming. The dynamic programming match process may also be used to match or time-align two sequences of acoustic observations or to match two models or networks. The dynamic programming computation can be used for example to find the best scoring path through a network or to find the sum of the probabilities of all the paths through the network. The prior usage of the term “dynamic programming” varies. It is sometimes used specifically to mean a “best path match” but its usage for purposes of this patent covers the broader class of related computational methods, including “best path match,” “sum of paths” match and approximations thereto. A time alignment of the model to the sequence of acoustic observations is generally available as a side effect of the dynamic programming computation of the match score. Dynamic programming may also be used to compute the degree of match between two models or networks (rather than between a model and a sequence of observations). Given a distance measure that is not based on a set of models, such as spectral distance, dynamic programming may also be used to match and directly time align two instances of speech elements.

“Best path match” is a process of computing the match between a network and a sequence of acoustic observations in which, at each node at each point in the acoustic sequence, the cumulative score for the node is based on choosing the best path for getting to that node at that point in the acoustic sequence. In some examples, the best path scores are computed by a version of dynamic programming sometimes called the Viterbi algorithm from its use in decoding convolutional codes. It may also be called the Dykstra algorithm or the Bellman algorithm from independent earlier work on the general best scoring path problem.

“Hypothesis” is a hypothetical proposition partially or completely specifying the values for some set of speech elements. Thus, a hypothesis is typically a sequence or a combination of sequences of speech elements. Corresponding to any hypothesis is a sequence of models that represent the speech elements. Thus, a match score for any hypothesis against a given set of acoustic observations, in some embodiments, is actually a match score for the concatenation of the models for the speech elements in the hypothesis.

“Sentence” is an interval of speech or a sequence of speech elements that is treated as a complete unit for search or hypothesis evaluation. Generally, the speech will be broken into sentence length units using an acoustic criterion such as an interval of silence. However, a sentence may contain internal intervals of silence and, on the other hand, the speech may be broken into sentence units due to grammatical criteria even when there is no interval of silence. The term sentence is also used to refer to the complete unit for search or hypothesis evaluation in situations in which the speech may not have the grammatical form of a sentence, such as a database entry, or in which a system is analyzing as a complete unit an element, such as a phrase, that is shorter than a conventional sentence.

“Modeling” is the process of evaluating how well a given sequence of speech elements match a given set of observations typically by computing how a set of models for the given speech elements might have generated the given observations. In probability modeling, the evaluation of a hypothesis might be computed by estimating the probability of the given sequence of elements generating the given set of observations in a random process specified by the probability values in the models. Other forms of models, such as neural networks may directly compute match scores without explicitly associating the model with a probability interpretation, or they may empirically estimate an a posteriori probability distribution without representing the associated generative stochastic process.

“Training” is the process of estimating the parameters or sufficient statistics of a model from a set of samples in which the identities of the elements are known or are assumed to be known. In supervised training of acoustic models, a transcript of the sequence of speech elements is known, or the speaker has read from a known script. In unsupervised training, there is no known script or transcript other than that available from unverified recognition. In one form of semi-supervised training, a user may not have explicitly verified a transcript but may have done so implicitly by not making any error corrections when an opportunity to do so was provided.

“Acoustic model” is a model for generating a sequence of acoustic observations, given a sequence of speech elements. The acoustic model, for example, may be a model of a hidden stochastic process. The hidden stochastic process would generate a sequence of speech elements and for each speech element would generate a sequence of zero or more acoustic observations. The acoustic observations may be either (continuous) physical measurements derived from the acoustic waveform, such as amplitude as a function of frequency and time, or may be observations of a discrete finite set of labels, such as produced by a vector quantizer as used in speech compression or the output of a phonetic recognizer. The continuous physical measurements would generally be modeled by some form of parametric probability distribution such as a Gaussian distribution or a mixture of Gaussian distributions. Each Gaussian distribution would be characterized by the mean of each observation measurement and the covariance matrix. If the covariance matrix is assumed to be diagonal, then the multi-variant Gaussian distribution would be characterized by the mean and the variance of each of the observation measurements. The observations from a finite set of labels would generally be modeled as a non-parametric discrete probability distribution. However, other forms of acoustic models could be used. For example, match scores could be computed using neural networks, which might or might not be trained to approximate a posteriori probability estimates. Alternately, spectral distance measurements could be used without an underlying probability model, or fuzzy logic could be used rather than probability estimates.

“Language model” is a model for generating a sequence of linguistic elements subject to a grammar or to a statistical model for the probability of a particular linguistic element given the values of zero or more of the linguistic elements of context for the particular speech element.

“General Language Model” may be either a pure statistical language model, that is, a language model that includes no explicit grammar, or a grammar-based language model that includes an explicit grammar and may also have a statistical component.

“Grammar” is a formal specification of which word sequences or sentences are legal (or grammatical) word sequences. There are many ways to implement a grammar specification. One way to specify a grammar is by means of a set of rewrite rules of a form familiar to linguistics and to writers of compilers for computer languages. Another way to specify a grammar is as a state-space or network. For each state in the state-space or node in the network, only certain words or linguistic elements are allowed to be the next linguistic element in the sequence. For each such word or linguistic element, there is a specification (say by a labeled arc in the network) as to what the state of the system will be at the end of that next word (say by following the arc to the node at the end of the arc). A third form of grammar representation is as a database of all legal sentences.

“Stochastic grammar” is a grammar that also includes a model of the probability of each legal sequence of linguistic elements.

“Pure statistical language model” is a statistical language model that has no grammatical component. In a pure statistical language model, generally every possible sequence of linguistic elements will have a non-zero probability.

“Pass.” A simple speech recognition system performs the search and evaluation process in one pass, usually proceeding generally from left to right, that is, from the beginning of the sentence to the end. A multi-pass recognition system performs multiple passes in which each pass includes a search and evaluation process similar to the complete recognition process of a one-pass recognition system. In a multi-pass recognition system, the second pass may, but is not required to be, performed backwards in time. In a multi-pass system, the results of earlier recognition passes may be used to supply look-ahead information for later passes.

The present invention according to at least one embodiment is directed to a name and address recognition in which a caller speaks a name that is expected to be in a telephone directory, whereby, unknown to the caller, the telephone directory only has the first initial, rather than the first name, of the person being named by the caller.

In a first embodiment, a telephone information retrieval system and method first tries to recognize the utterance of the caller as an exact match to the form as stored in a telephone directory database. Then, for the best matching entries, the utterance is recognized again with a grammar in which the initial in the telephone directory database is replaced by a list of all first names in the telephone directory database that begin with that same initial.

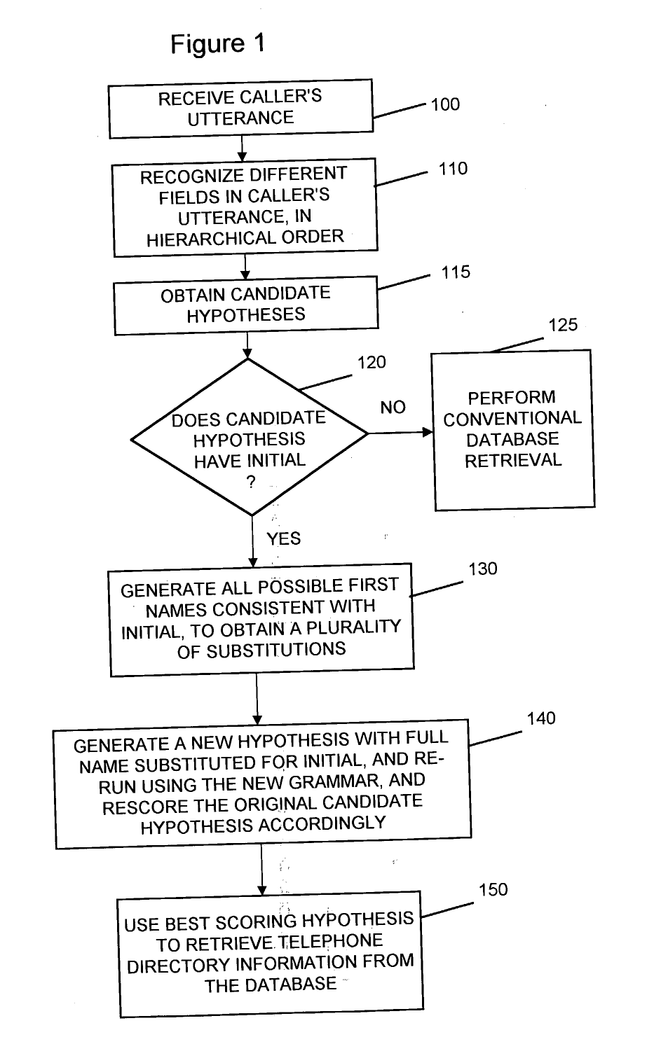

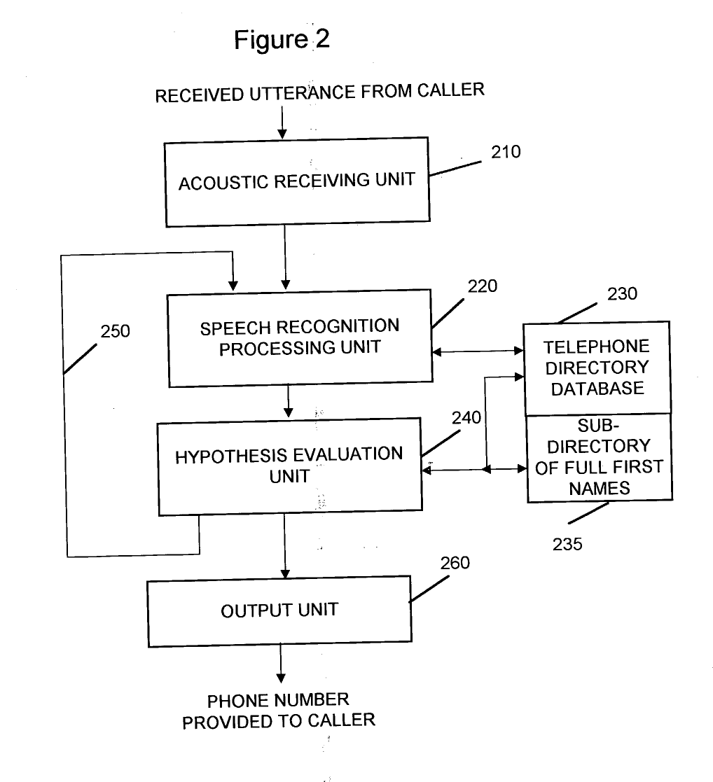

The present invention according to the first embodiment will be described below in more detail with reference to the flow chart in FIG. 1 and the system block diagram in FIG. 2. In a first step 100, a caller's utterance is received (by acoustic receiving unit 210 in FIG. 2). By way of example and not by way of limitation, the caller's utterance corresponds to a “City and State” (in response to a first voice prompt that the caller hears after a telephone information phone number is called and answered), and a “First Name and Last Name” (in response to a second voice prompt that the caller hears).

In a second step 110, the different fields corresponding to the caller's utterance are recognized in hierarchical order, preferably with the first name recognized last (with this recognition being performed by the speech recognition processing unit 220 in FIG. 2, which queries the telephone directory database 230). In the example given above, there are four different fields to be recognized in the following hierarchical order: a) the City, b) the State, c) the Last Name, and d) the First Name.

The City corresponds to a beginning part of the caller's first utterance (in response to the first voice prompt), and the State corresponds to an ending part (separated from the beginning part of the next utterance by a pause) of the caller's first utterance. The Last Name corresponds to the ending part of the caller's second utterance (in response to the second voice prompt), and the First Name corresponds to a beginning part (separated from the ending part of the previous utterance by a pause) of the caller's second utterance.

After all of the database fields have been recognized, a speech recognition database retrieval is performed, in step 115, to obtain a plurality of candidate hypotheses.

In a third step 120, it is determined whether or not a speech recognition hypothesis to be evaluated has an initial, abbreviation or nickname (which is determined by hypothesis evaluating unit 240 in FIG. 2). By way of example, in one embodiment, the initial would be detected by determining that there is only one letter in the name. The nickname or abbreviation could be detected, for example, by comparing the first name field in the hypothesis against a table of allowable first names, in order to determine if there is a match. If the determination in step 120 is No, then a conventional database retrieval is performed, as in step 125. If the determination in step 120 is Yes, then in a step 130, at least one first name consistent with the initial, abbreviation or nickname is generated for that candidate hypothesis and acoustic and/or other data obtained therefor, to obtain at least one generated hypothesis with the full first name substituted for the first name initial, abbreviation or nickname in the generated hypothesis (the full first name is provided to the speech recognition processing unit 220 in FIG. 2 by way of data path 250 from the hypothesis evaluating unit 240).

In a step 140, for each generated hypotheses, in which a full first name is substituted for an initial, speech recognition is performed again using the full first names for the initial as a new grammar (with that speech recognition performed by the speech recognition processing unit 220 in FIG. 2). The original candidate hypothesis having an initial for the first name field is given the score from its generated hypothesis if the generated hypothesis has a better score, and the initial is replaced with the full first name of the generated hypothesis in this case. If the generated hypothesis has a worse score, then the first name initial is maintained for the candidate hypothesis (since it is possible that the caller uttered an initial for the first name of the person whose phone number is desired).

In a step 150, the best scoring candidate hypothesis is used to retrieve a corresponding entry from the telephone database (which corresponds to element 230 in FIG. 2, with the telephone directory information output from output unit 260 in FIG. 2).

The list of full first names for an initial is preferably obtained from information within the telephone directory database 230 itself, whereby queries are performed on the database entries, preferably beforehand, and that information is stored in a particular memory region. This memory region is shown as Sub-directory of Full First Names 235 in FIG. 2. For each initial, a hierarchical order of full first names can be maintained based on the number of occurrences of the corresponding full first name in the database 230, for example. As such, a user can elect to only expand the grammar for the first name initial to include the top L (L being an integer) full first names stored in the Sub-directory of Full First Names 235.

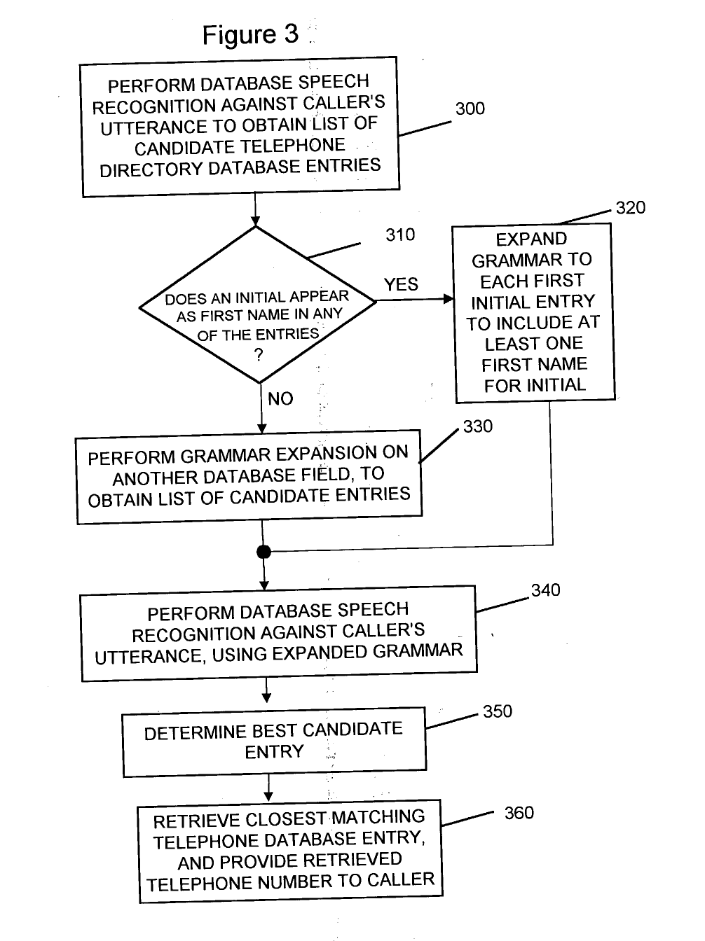

A second embodiment of the invention is described below with reference to FIG. 3. In the second embodiment, assume that a speaker utters a first name, last name, street address, city and state in response to one or more voice prompts that the speaker hears after connecting with a telephone number that one calls to obtain telephone directory assistance. In FIG. 3, in a step 300, a list of candidate telephone directory database entries are obtained based on a caller's utterance, in a manner known to those skilled in the art.

If more than one candidate telephone directory entry is in the list, then in a step 310, it is determined whether or not an initial appears as the first name in any of the list of candidate telephone directory database entries. If the determination in step 310 is Yes, then in a step 320, at least one “first initial” entry in the list of candidate directory entries is expanded, as an expanded grammar, to include at least one possible first name for that initial, as obtained from the database. In an alternative embodiment, all possible full first names for that initial are used to provide an expanded grammar. If the determination in step 310 is No, then in a step 330, a grammar expansion is performed on another database field, e.g., the street address, in order to obtain an expanded list of candidate directory entries.

In a step 340, database speech recognition is performed against the caller's utterance using the expanded grammar. This amounts to a second speech recognition performed on the caller's utterance. From this second speech recognition pass, in a step 350, the best speech recognition candidate hypothesis is obtained.

In a step 360, the corresponding telephone database entry for the best candidate hypothesis is retrieved, and a telephone number obtained from that database entry is provided to the caller as the desired telephone number.

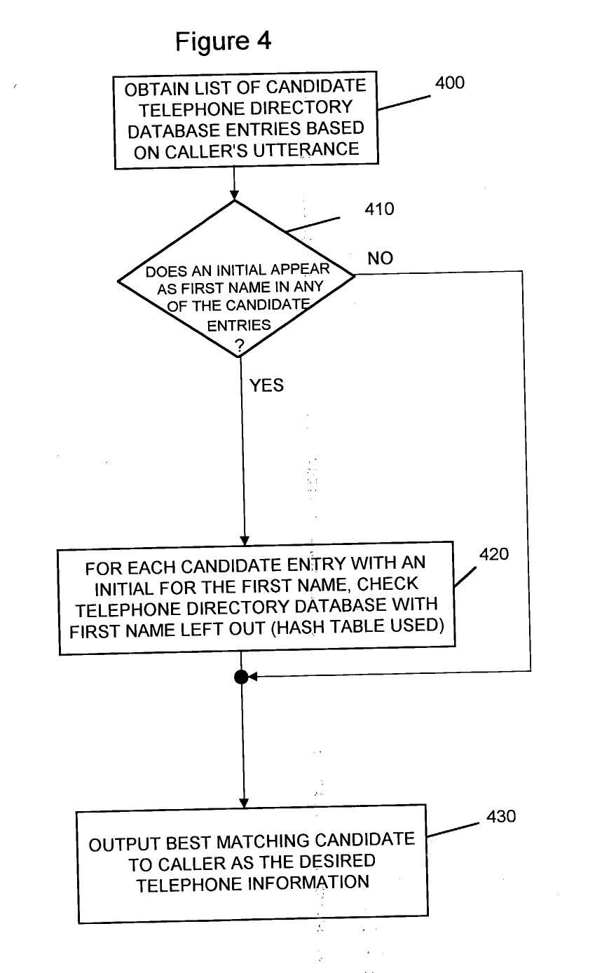

In a third embodiment, which is shown in FIG. 4, in a step 400 a list of candidate telephone directory entries are obtained based on the caller's utterance. In a step 410, a determination is made as to whether any of the candidate entries has an initial for the first name. If the determination in step 410 is No, then the process proceeds to step 430. If the determination in step 410 is Yes, then the process proceeds to step 420, whereby, for each candidate entry with an initial for the first name, the telephone directory database is checked with the first name left out, by utilizing an error correction method such as described in co-pending U.S. patent application Ser. No. 10/348,780, which is assigned to the same assignee as this application, and which uses hash tables to determine best matches with gaps with respect to database entries. With the first name being the “gap”, the telephone directory database is checked to find any entries that are the same as the caller's utterance without the first name being spoken. In the step 430, from the list of candidates, the best matching candidate is output to the caller as the desired information. Unlike the second embodiment in which two separate speech recognition passes are made, only one speech recognition pass is performed in the third embodiment.

However, with the third embodiment, the possibility increases that more than one database entry matches the caller's utterance with the first name omitted, especially when the last name is a common last name (e.g., Smith or Johnson). In that case, in one possible implementation of the third embodiment, the caller would be prompted, by way of a voice prompt, to provide additional information on the person for whom a telephone number is desired. For example, the caller would be prompted to provide a complete address, including the street address, of the person who the caller wants to call. With this additional information, the list of database matches would be narrowed down to (hopefully) one match.

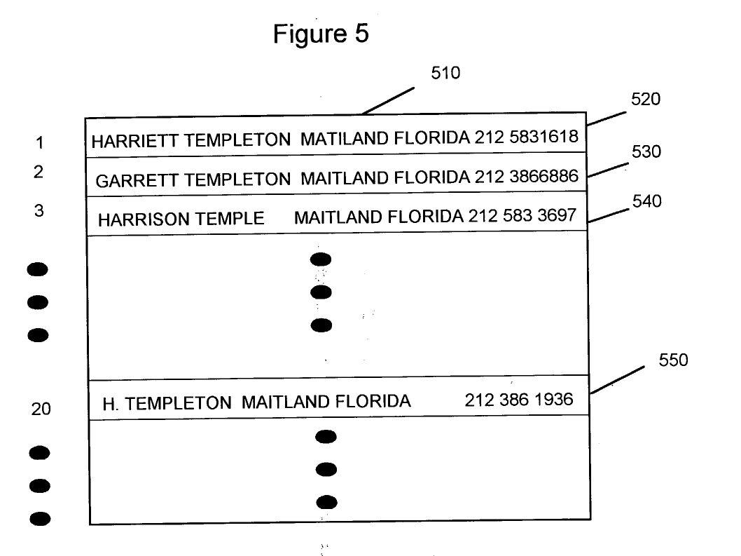

FIG. 5 shows an example in which the caller utters “Maitland Florida” in response to a “City and State” automatic voice prompt, and “Harrison Templeton” in response to a “First Name and Last Name” automatic voice prompt.

A telephone directory database is queried based on the caller's utterance, as output by a speech recognition unit, by performing a speech recognition database retrieval with respect to the caller's utterance, such as by using a priority queue speech recognition process. For example, the three best (1, 2, 3) matching database entries 520, 530, 540 through at least the twentieth-best (20^{th}) matching database entry 550 are obtained and placed in a priority queue 510, as shown in FIG. 5. The best and second-best matching database entries 520, 530 have slightly different sounding first names, but they have the same last name, city and state as the caller's utterance. The third-best matching database entry 540 has a slightly different last name, but the same first name, city and state as the caller's utterance. The twentieth-best (20^{th}) matching database entry 550 has the same last name, city and state as the caller's utterance, but it has an initial provided for the first name. According to the present invention, the initial is expanded to all possible first names that correspond to that initial, and, assuming that the first name “Harrison” appears somewhere in the telephone directory database, and as such is stored in the Sub-directory of Full First Names 235 as shown in FIG. 2. Eventually the priority queue search process extends all of the partial hypotheses that are initially placed higher in the priority queue than the expansions of this twentieth-best matching database entry, but none of these extensions is an exact match for the full name and address. Finally, the priority queue search process will also expand this twentieth-best matching database entry, and an exact match to the caller's utterance is made by expanding the twentieth-best matching database entry using an expanded grammar of all possible first names. Accordingly, assuming that a priority queue speech recognition technique is used in this example, the 20^{th}-best matching database entry 550 is moved up in the priority queue 510 to the highest (1^{st}) position, and it is used to retrieve the proper telephone number, 212-386-1936, from the telephone directory database. As a result, the caller is provided with the correct telephone number of Harrison Templeton, as obtained from the “H. Templeton, Maitland, Fla.” database entry.

Similarly, if the telephone directory database contains a nickname, e.g., Harry, or an abbreviation, e.g., Har., for the first name, then the database entry can be correctly matched to the caller's utterance by way of the present invention.

As explained earlier with respect to one embodiment, an address can be expanded from the list of candidate hypotheses, to obtain an expanded grammar. This can be done, for example, when no candidate hypotheses closely match the caller's utterance, even after a first full name substitution was performed as described with respect to the first embodiment. In this instance, a caller is prompted (by way of a voice prompt) to speak a street number and street name along with city, state, first name and last name, the list of candidate hypotheses is expanded using the street number and street name information from the top M (M being an integer greater than one) in the list of candidate hypotheses. This expanded street address grammar is used to perform a second speech recognition pass on the caller's utterance.

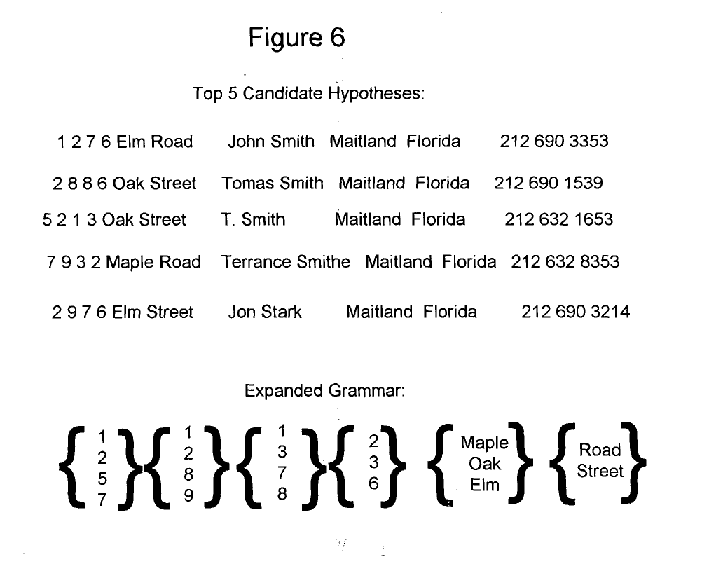

Referring now to FIG. 6, which shows the top five candidate hypotheses, an expanded grammar is obtained, to include all possible permutations of the street address and street name. For instance, with this expanded grammar, 5836 Maple Street would be an acceptable street address and street name.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps. It should also be noted that the word “module” or “component” or “unit” as used herein and in the claims is intended to encompass implementations using one or more lines of software code, and/or hardware implementations, and/or equipment for receiving manual inputs.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

For example, it is possible to have the caller provide a nickname or abbreviation for the first name of the person whose phone number is desired, whereby the correct database entry contains the full first name. In that case, the same features as described above with respect to the different embodiments may be utilized to match these two different names together, in order to provide the caller with the correct telephone information. Also, the same features can be used to provide a caller with information other than from a person, such as a company, whereby the caller utters a different name (e.g., IBM) than what is stored in a telephone directory database (e.g., International Business Machines).

What is claimed is:

1. A method for obtaining telephone directory information from a database, comprising:
a) performing a first speech recognition processing on a speaker's utterance, in order to obtain a list of candidate hypotheses that have corresponding database entries in the database;
b) determining whether or not any of the list of candidate hypotheses has an initial, abbreviation or nickname for a part of the corresponding database entry;
c) if the determination in step b) is that at least one of the list of candidate hypotheses has an initial, abbreviation or nickname for the part, then performing the following steps for that candidate hypothesis:
d) generating at least one substitution consistent with the initial, abbreviation or nickname, and obtaining at least one generated hypothesis that includes the generated substitution;
e) performing a second speech recognition processing for the sequence of acoustic observations with respect to the at least one generated hypothesis, and obtaining a match score for each of the at least one generated hypotheses with respect to the caller's utterance; and
f) determining a highest match score of the list of candidate hypotheses as a recognized answer to be utilized to retrieve the telephone directory information from the database, wherein the match score of the at least one generated hypothesis is used instead of the match score of its corresponding candidate hypothesis if the match score of the generated hypothesis is greater than the match score of its corresponding candidate hypothesis.

2. The method according to claim 1, further comprising:
if the determination in step b) is that none of the list of candidate hypotheses has an initial, abbreviation or nickname for the part, then determining one of the list of candidate hypotheses having a highest matching score as a recognized answer, which is used to retrieve the telephone directory information from the database.

3. The method according to claim 1, wherein a plurality of generated hypotheses are obtained in step d), and correspond to an expanded grammar utilized in the second speech recognition processing.

4. The method according to claim 1, wherein the second speech recognition processing is performed with an expanded grammar by expanding at least one field of entries stored in the database, based on corresponding information in the at least one field of entries as obtained from the list of candidate hypotheses.

5. The method according to claim 1, wherein the second speech recognition processing performed in step e). is performed using a grammar different than what is used by the first speech recognition processing performed in step a).

6. The method according to claim 1, further comprising:
if there are at least two of the candidate hypotheses that exceed a predetermined match score value, or none of the candidate hypotheses exceed the predetermined match score, then requesting additional information from the speaker with regards to the person for whom the, speaker desires to be provided with a telephone number; and
performing the second speech recognition processing using an expanded grammar that includes the additional information.

7. The method according to claim 1, wherein the sequence of acoustic observations corresponds to a sequence of phonemes.

8. The method according to claim 1, wherein the sequence of acoustic observations corresponds to a sequence of words.

9. The method according to claim 1, wherein the substitutions generated in step d) are obtained from information stored in the database.

10. The method according to claim 1, wherein the part of the candidate database entry is a first name.

11. The method according to claim 3, further comprising:
creating a grammar for a field entry from the list of candidate hypotheses.

12. The method according to claim 4, further comprising:
creating a grammar for a field entry from the list of candidate hypotheses.

13. The method according to claim 5, further comprising:
creating a grammar for a field entry from the list of candidate hypotheses, by selecting from the telephone directory for the corresponding field an entry that is consistent with the initial, abbreviation or nickname.

14. A system for obtaining telephone directory information from a database, comprising:
a speech recognition processing unit configured to perform a first speech recognition processing on a speaker's utterance, in order to obtain a list of candidate hypotheses that have corresponding database entries in the database; and
a hypothesis evaluation unit configured to determine whether or not any of the list of candidate hypotheses output by the speech recognition processing unit has an initial, abbreviation or nickname for a part of the corresponding database entry,
wherein, when the determination by the hypothesis evaluation unit is that at least one of the list of candidate hypotheses has an initial, abbreviation or nickname for the part, then the hypothesis evaluation unit generates at least one substitution consistent with the initial, abbreviation or nickname, and obtains at least one generated hypothesis that includes the generated substitution,
wherein the speech recognition processing unit performs a second speech recognition processing for the sequence of acoustic observations with respect to the at least one generated hypothesis provided to the speech recognition processing unit by the hypothesis evaluation unit, and wherein a match score is obtained for each of the at least one generated hypotheses with respect to the caller's utterance,
wherein a highest match score of the list of candidate hypotheses is determined to be a recognized answer that is utilized to retrieve the telephone directory information from the database, and
wherein the match score of the at least one generated hypothesis is used instead of the match score of its corresponding candidate hypothesis if the match score of the generated hypothesis is greater than the match score of its corresponding candidate hypothesis.

15. The system according to claim 14, wherein,
when the determination by the hypothesis evaluation unit is that none of the list of candidate hypotheses has an initial, abbreviation or nickname for the first name part, then one of the list of candidate hypotheses having a highest matching score is determined to be a recognized answer, which is utilized to retrieve the telephone directory information from the database.

16. The system according to claim 14, wherein a plurality of generated hypotheses are obtained by the hypothesis evaluation unit, and correspond to an expanded grammar utilized in the second speech recognition processing.

17. The system according to claim 14, wherein the second speech recognition processing is performed with an expanded grammar by expanding at least one field of entries stored in the database, based on corresponding information in the at least one field of entries as obtained from the list of candidate hypotheses.

18. The system according to claim 14, wherein the second speech recognition processing is performed using a grammar different than what is used by the first speech recognition processing.

19. The system according to claim 14, further comprising:
an additional information requesting unit,
wherein, if there are at least two of the candidate hypotheses that exceed a predetermined match score value, or none of the candidate hypotheses exceed the predetermined match score, then the additional information requesting unit requests additional information from the speaker with regards to the person for whom the speaker desires to be provided with a telephone number,
wherein the second speech recognition processing is performed by the speech recognition processing unit, using an expanded grammar that includes the additional information.

20. The system according to claim 14, wherein the sequence of acoustic observations corresponds to a sequence of phonemes.

21. The system according to claim 14, wherein the sequence of acoustic observations corresponds to a sequence of words.

22. The system according to claim 14, wherein the substitutions generated by the hypothesis evaluation unit are obtained from information stored in the database.

23. The system according to claim 14, wherein the part of the corresponding database entry is a first name.

24. A program product having machine readable code for obtaining telephone directory information from a database, the program code, when executed, causing a machine to perform the following steps:
a) performing a first speech recognition processing on a speaker's utterance, in order to obtain a list of candidate hypotheses that have corresponding database entries in the database;
b) determining whether or not any of the list of candidate hypotheses has an initial, abbreviation or nickname for a part of the corresponding database entry;
c) if the determination in step b) is that at least one of the list of candidate hypotheses has an initial, abbreviation or nickname for the part, then performing the following steps for that candidate hypothesis:
d) generating at least one substitution consistent with the initial, abbreviation or nickname, and obtaining at least one generated hypothesis that includes the generated substitution;
e) performing a second speech recognition processing for the sequence of acoustic observations with respect to the at least one generated hypothesis, and obtaining a match score for each of the at least one generated hypotheses with respect to the caller's utterance; and
f) determining a highest match score of the list of candidate hypotheses as a recognized answer to be utilized to retrieve the telephone directory information from the database, wherein the match score of the at least one generated hypothesis is used instead of the match score of its corresponding candidate hypothesis if the match score of the generated hypothesis is greater than the match score of its corresponding candidate hypothesis.

25. The program product according to claim 24, further comprising:
if the determination in step b) is that none of the list of candidate hypotheses has an initial, abbreviation or nickname for the part, then determining one of the list of candidate hypotheses having a highest matching score as a recognized answer, which is utilized to retrieve the telephone directory information from the database.

26. The program product according to claim 24, wherein a plurality of generated hypotheses are obtained in step d), and correspond to an expanded grammar utilized in the second speech recognition processing.

27. The program product according to claim 24, wherein the second speech recognition processing is performed with an expanded grammar by expanding at least one field of entries stored in the database, based on corresponding information in the at least one field of entries as obtained from the list of candidate hypotheses.

28. The program product according to claim 24, wherein the second speech recognition processing performed in step e) is performed using a grammar different than what is used by the first speech recognition processing performed in step a).

29. The program product according to claim 24, further comprising:
if there are at least two of the candidate hypotheses that exceed a predetermined match score value, or none of the candidate hypotheses exceed the predetermined match score, then requesting additional information from the speaker with regards to the person for whom the speaker desires to be provided with a telephone number; and
performing the second speech recognition processing using an expanded grammar that includes the additional information.

30. The program product according to claim 24, wherein the sequence of acoustic observations corresponds to a sequence of phonemes.

31. The program product according to claim 24, wherein the sequence of acoustic observations corresponds to a sequence of words.

32. The program product according to claim 24, wherein the substitutions generated in step d) are obtained from information stored in the database.

33. The program product according to claim 19, wherein the part of the corresponding database entry is a first name.
